(19) United States
(12) Patent Application Publication
(10) Pub. No.: US 2016/0007219 A1
(43) Pub. Date: Jan. 7, 2016

(54) RADIO BASE STATION

(71) Applicant: NTT DOCOMO, INC., Chiyoda-ku, Tokyo (JP)

(72) Inventors: Wuri Andarmawanti Hapsari, Tokyo (JP); Kenichiro Aoyagi, Tokyo (JP); Soulisak Ormsub, Tokyo (JP)

(73) Assignee: NTT DOCOMO, INC., Tokyo (JP)

(21) Appl. No.: 14/759,472

(22) PCT Filed: Jan. 9, 2014
(86) PCT No.: PCT/JP2014/050232

§ 371 Date: Jul. 7, 2015

(30) Foreign Application Priority Data
Jan. 9, 2013 (JP) 2013-001848

(51) Int. Cl. H04W 24/08; H04W 72/04; H04W 24/10

(52) U.S. Cl. CPC H04W 24/08; H04W 24/10; H04W 72/0453; H04W 88/08

(57) ABSTRACT

A radio base station of the invention includes: a measurement unit 12 configured to measure a throughput of an “Immediate MDT” target mobile station UE; and a management unit 13 configured to manage a CA-related state of the “Immediate MDT” target mobile station UE, together with the throughput of the “Immediate MDT” target mobile station UE which is measured by the measurement unit 12.

### TECHNICAL FIELD

The present invention relates to a radio base station.

### BACKGROUND ART

CA (Carrier Aggregation) is specified in LTE (Long Term Evolution) Release-10.

The CA is a technique for improving peak rate and throughput of data of a mobile station UE, and is achieved by performing communication while using two or more CCs (Component Carriers).

In order to achieve the CA, as shown in FIG. 3, a radio base station eNB needs to perform operations on the mobile station UE by: performing configuration for adding a Scell (Secondary cell) in a RRC (Radio Resource Control) layer; and then activating the Scell in a MAC (Media Access Control) layer, i.e. performing “Scell Activation”.

Thereafter, the radio base station eNB can perform configuration for changing and releasing the Scell and perform deactivation of the Scell, i.e. perform “Scell Deactivation,” on the mobile station UE.

Meanwhile, “MDT (Minimization of Drive Tests, measurement drive tests)” is also specified in LTE Release-10.

The MDT is a technique for reducing drive tests by a carrier (operator) and improving an OPEX (Operational Expenditure) and a CAPEX (Capital Expenditure).

The MDT is achieved by causing the mobile stations UE to report measurement results of radio quality to a network without using a special device for drive tests.

Two types of MDT which are “Immediate MDT” and “Logged MDT” are currently specified as the MDT.

The “Immediate MDT” is MDT performed when the mobile station UE is in an “RRC_Connected state.” As shown in FIG. 4, the mobile station UE set to perform the “Immediate MDT” is configured to report the measurement results of radio quality to the radio base station eNB in real time.

Meanwhile, the “Logged MDT” is MDT performed when the mobile station UE is in an “RRC_Idle state.” As shown in FIG. 4, the mobile station UE set to perform the “Logged MDT” is configured to temporarily save the measurement result of radio quality as a log and report the saved measurement result of radio quality to the radio base station eNB at a timing of switching to the “RRC_Connected state.”

Moreover, LTE Release-11 specifies that the radio base station eNB measures the throughput of a mobile station UE being a target of the “Immediate MDT” and manages the measured throughput as a log.

### PRIOR ART DOCUMENT

### Non-Patent Document

Non-patent document 1: 3GPP TS 36.300

Non-patent document 2: 3GPP TS 37.320

Non-patent document 3: 3GPP TS 36.331

### SUMMARY OF THE INVENTION

However, the conventional MDT has a problem that the carrier cannot check the throughput of a mobile station UE performing the CA.

Specifically, the conventional MDT has a problem that the radio base station eNB cannot report the throughput of a mobile station UE performing the CA to a TCE (Trace Collection Entity) in a manner distinguishable from the throughput of a mobile station UE performing no CA.

The present invention has been made in view of the problem described above, and an objective thereof is to provide a radio base station capable of reporting the throughput of a mobile station UE performing the CA.

A first feature of the present invention is summarized as a radio base station including: a measurement unit configured to measure a throughput of a MDT target mobile station; and a management unit configured to manage a state related to carrier aggregation of the target mobile station, together with the throughput of the target mobile station which is measured by the measurement unit.

### BRIEF DESCRIPTION OF THE DRAWINGS

FIG. 1 is an overall configuration view of a mobile communication system in a first embodiment of the present invention.

FIG. 2 is a functional block diagram of a radio base station in the first embodiment of the present invention.

FIG. 3 is a view for explaining a prior art.

FIG. 4 is a view for explaining a prior art.

### MODE FOR CARRYING OUT THE INVENTION

### (Mobile Communication System in First Embodiment of Present Invention)

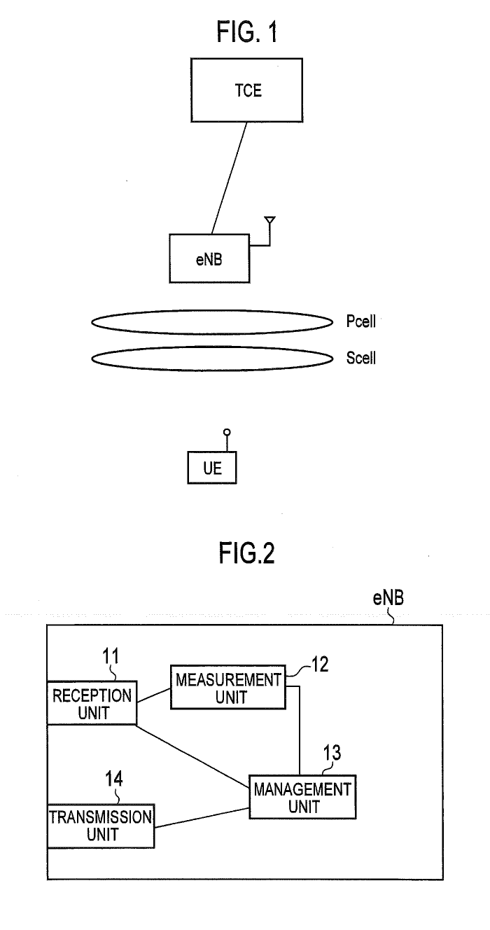

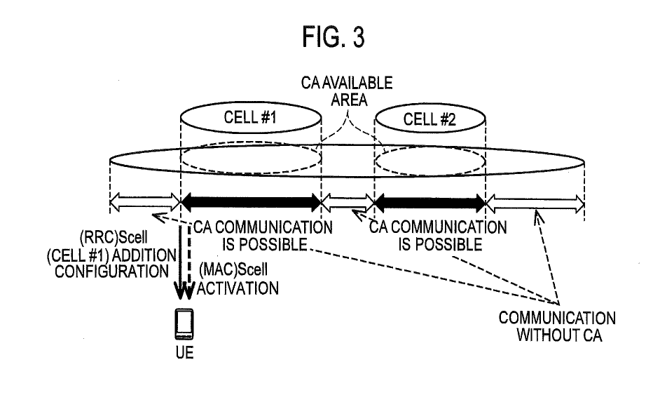

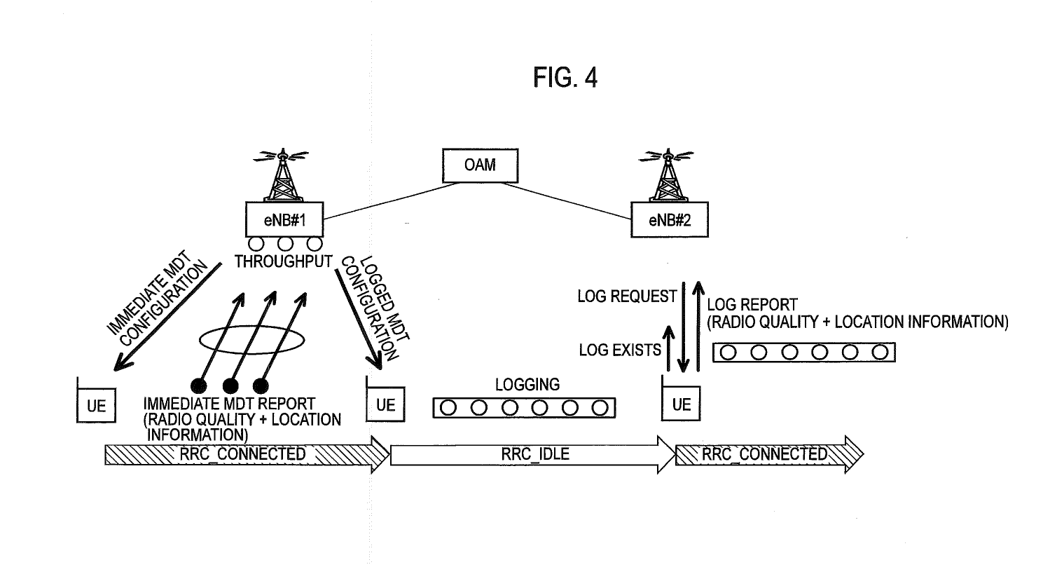

A mobile communication system in a first embodiment of the present invention is described with reference to FIGS. 1 and 2.

As shown in FIG. 1, the mobile communication system of the embodiment includes a TCE (Trace Collection Entity) which is a MDT server, a radio base station eNB, and the like.

In the mobile communication system of the embodiment, “Immediate MDT” and “Logged MDT” specified in LTE Release-11 can be achieved.

In the example of FIG. 1, a mobile station UE is assumed to perform CA by using a Pcell which is a serving cell of a PCC (Primary Carrier) and a Scell which is a serving cell of a SCC (Secondary Carrier).

Moreover, in the example of FIG. 1, the mobile station UE is assumed to be configured to perform the “Immediate MDT.”

As shown in FIG. 2, the radio base station eNB includes a reception unit 11, a measurement unit 12, a management unit 13, and a transmission unit 14.

The reception unit 11 is configured to receive various signals from the mobile station UE and the TCE.

For example, the reception unit 11 is configured to receive a “Measurement Report” from the mobile station UE, the “Measurement Report” indicating that Events A1 to A6, B1, and B2 are satisfied. Moreover, the reception unit 11 may be configured to acquire information on the location of the mobile station UE.

The measurement unit 12 is configured to measure the throughput of the mobile station UE which is a MDT (specifically, “Immediate MDT”) target mobile station.

The management unit 13 is configured to manage a CA-related state of the “Immediate MDT” target mobile station, together with the throughput of the target mobile station which is measured by the measurement unit 12.

The management unit 13 may be configured to manage log information on addition or release of the Scell, as the aforementioned CA-related state.

For example, such log information may include a fact that the Scell is added or released, a time at which the addition or release of the Scell is performed, and the like.

The radio base station eNB is configured to add the Scell in response to “Scell Addition” in “RRC Connection Reconfiguration” and to release the Scell in response to “Scell Release” in “RRC Connection Reconfiguration.”

Moreover, the management unit 13 may be configured to manage log information on activation of the Scell (Scell activation) or deactivation of the Scell (Scell deactivation), as the aforementioned CA-related state.

For example, such log information may include a fact that the Scell is activated or deactivated, a time at which the activation or deactivation of the Scell is performed, and the like.

The radio base station eNB is configured to activate and deactivate the configured Scell in a MAC layer.

The transmission unit 14 is configured to transmit various signals to the mobile station UE and the TCE.

For example, the transmission unit 14 is configured to send the TCE the throughput of the “Immediate MDT” target mobile station UE and the CA-related state of the “Immediate MDT” target mobile station UE which are managed by the management unit 13, together with the “Events A1 to A6, B1, and B2” and “RSRQ (Reference Signal Received Quality) and RSRP (Reference Signal Received Power)” which are acquired from the “Immediate MDT” target mobile station UE.

Furthermore, the transmission unit 14 may be configured to further send the TCE the information on the location of the “Immediate MDT” target mobile station UE.

The features of the present embodiment may also be expressed as follows.

A first feature of the present embodiment is summarized as a radio base station eNB including: a measurement unit 12 configured to measure a throughput of a “Immediate MDT” target mobile station UE; and a management unit 13 configured to manage a state related to CA of the “Immediate MDT” target mobile station UE, together with the throughput of the “Immediate MDT” target mobile station UE which is measured by the measurement unit 12.

In such a configuration, the throughput of the “Immediate MDT” target mobile station UE performing the CA which is to be reported to a carrier can be managed by the radio base station eNB in a manner distinguishable from the throughput of the “Immediate MDT” target mobile station UE performing no CA.

In the first feature of the present embodiment, the management unit 13 may manage log information on addition and release of a Scell (Secondary cell), as the state related to the CA.

In such a configuration, the radio base station eNB can manage the fact of whether the Scell is configured in the “Immediate MDT” target mobile station UE.

In the first feature of the present embodiment, the management unit 13 may manage log information on activation or deactivation of the Scell, as the state related to the CA.

In such a configuration, the radio base station eNB can manage the fact of whether the Scell configured in the “Immediate MDT” target mobile station UE is activated.

In the first feature of the present embodiment, the radio base station eNB further may include a transmission unit 14 configured to send a TCE (predetermined server) the throughput of the “Immediate MDT” target mobile station UE and the state related to the CA of the “Immediate MDT” target mobile station UE which are managed by the management unit 13, together with “RSRQ and RSRP (radio quality)” and “Events A1 to A6, B1, and B2 (event information)” acquired from the “Immediate MDT” target mobile station UE.

In such a configuration, the carrier can check the throughput of the “Immediate MDT” target mobile station UE based on the information reported by the radio base station eNB to the TCE.

In the first feature of the present embodiment, the transmission unit 14 further may send the TCE information on a location of the “Immediate MDT” target mobile station UE.

In such a configuration, the carrier can also check the information on the location of the “Immediate MDT” target mobile station UE.

It should be noted that the foregoing operations of the mobile station UE, the radio base station eNB, and the TCE may be implemented by hardware, may be implemented by a software module executed by a processor, or may be implemented in combination of the two.

The software module may be provided in a storage medium in any format, such as a RAM (Random Access Memory), a flash memory, a ROM (Read Only Memory), an EPROM (Erasable Programmable ROM), an EEPROM (Electronically Erasable and Programmable ROM), a register, a hard disk, a removable disk, or a CD-ROM.

The storage medium is connected to a processor so that the processor can read and write information from and to the storage medium. Instead, the storage medium may be integrated in a processor. The storage medium and the processor may be provided inside an ASIC. Such an ASIC may be provided in the mobile station UE, the radio base station eNB, and the TCE. Otherwise, the storage medium and the processor may be provided as discrete components inside the mobile station UE, the radio base station eNB, and the TCE.

Hereinabove, the present invention has been described in detail by use of the foregoing embodiments. However, it is apparent to those skilled in the art that the present invention should not be limited to the embodiments described in the specification. The present invention can be implemented as an altered or modified embodiment without departing from the spirit and scope of the present invention, which are determined by the description of the scope of claims. Therefore, the description of the specification is intended for illustrative explanation only and does not impose any limited interpretation on the present invention.

Note that the entire content of Japanese Patent Application No. 2013-001848 (filed on Jan. 9, 2013) is incorporated by reference in the present specification.

### INDUSTRIAL APPLICABILITY

As described above, the present invention can provide a radio base station which can report the throughput of a mobile station UE performing CA.

### EXPLANATION OF THE REFERENCE NUMERALS

UE mobile station

eNB radio base station

11 reception unit

12 measurement unit

13 management unit

14 transmission unit

1. A radio base station comprising:
a measurement unit configured to measure a throughput of a MDT (Minimization of Drive Tests) target mobile station; and
a management unit configured to manage a state related to carrier aggregation of the target mobile station, together with the throughput of the target mobile station which is measured by the measurement unit.

2. The radio base station according to claim 1, wherein the management unit manages log information on addition and release of a secondary cell, as the state related to the carrier aggregation.

3. The radio base station according to claim 1, wherein the management unit manages log information on activation or deactivation of a secondary cell, as the state related to the carrier aggregation.

4. The radio base station according to claim 1, further comprising a transmission unit configured to send a predetermined server the throughput of the target mobile station and the state related to the carrier aggregation of the target mobile station which are managed by the management unit, together with radio quality and event information acquired from the target mobile station.

5. The radio base station according to claim 4, wherein the transmission unit further sends the predetermined server information on a location of the target mobile station.

6. The radio base station according to claim 2, further comprising a transmission unit configured to send a predetermined server the throughput of the target mobile station and the state related to the carrier aggregation of the target mobile station which are managed by the management unit, together with radio quality and event information acquired from the target mobile station.

7. The radio base station according to claim 3, further comprising a transmission unit configured to send a predetermined server the throughput of the target mobile station and the state related to the carrier aggregation of the target mobile station which are managed by the management unit, together with radio quality and event information acquired from the target mobile station.

8. The radio base station according to claim 6, wherein the transmission unit further sends the predetermined server information on a location of the target mobile station.

9. The radio base station according to claim 7, wherein the transmission unit further sends the predetermined server information on a location of the target mobile station.
